(19) United States
(12) Patent Application Publication
(10) Pub. No.: US 2017/0162942 A1
(43) Pub. Date: Jun. 8, 2017

(54) MONOPOLE ANTENNA

(71) Applicant: ARCADYAN TECHNOLOGY CORPORATION, Hsinchu City (TW)

(72) Inventors: Min-Chi WU, Zhubei City (TW); Kuo-Chang LO, Toufen Township (TW)

(21) Appl. No.: 15/224,105

(22) Filed: Jul. 29, 2016

(30) Foreign Application Priority Data
Dec. 4, 2015 (TW) 104140810

(51) Int. Cl. H01Q 5/392; H01Q 1/48

(52) U.S. Cl. CPC H01Q 5/392; H01Q 1/48

(57) ABSTRACT

A dual-band monopole antenna includes a ground portion, a first radiator, a second radiator and a feed portion. The first radiator includes a first extension portion extended towards the ground portion, a second extension portion extended and perpendicular to the first extension portion, a third extension portion extended and perpendicular to the second extension portion, and a fourth extension portion extended and perpendicular to the third extension portion. The second radiator includes a fifth extension portion extended and parallel to the second extension portion, and a sixth extension portion parallel to the first extension portion. The feed portion has one end connected to the first extension portion and the other end corresponds to the ground portion.

This application claims the benefit of Taiwan application Serial No. 104140810, filed Dec. 4, 2015, the disclosure of which is incorporated by reference herein in its entirety.

### TECHNICAL FIELD

The disclosure relates in general to a monopole antenna, and more particularly to a dual-band monopole antenna.

### BACKGROUND

Today with the advance and development in science and technology, various types of antennas have been provided and used in various types of electronic devices such as mobile phones, notebook computers, tablet PCs, and wireless access points. Of the various types of antennas, monopole antenna is most commonly used.

In response to the needs of wireless data transmission under different frequency bands, the monopole antenna is normally capable of operating under different bands. However, conventional multi-band monopole antenna can hardly be adjusted with respect to separate operating band independently, and once the operating band changes, the antenna designer has to spend a large amount of time adjusting antenna structure to achieve desired operating band.

Therefore, how to provide a multi-band monopole antenna allowing the designer to adjust separate operating bands independently has become a prominent task for the industries.

### SUMMARY

The disclosure is directed to a dual-band monopole antenna allowing the designer to adjust separate operating band independently.

According to one embodiment of the disclosure, a dual-band monopole antenna is provided. The dual-band monopole antenna includes a ground portion, a first radiator, a second radiator and a feed portion. The first radiator is disposed adjacent to the ground portion and includes a first extension portion, a second extension portion, a third extension portion and a fourth extension portion. The first extension portion is extended towards the ground portion along a first direction. The second extension portion is coupled to one end of the first extension portion and extended along the second direction to be perpendicular to the first extension portion. The third extension portion is coupled to one end of the second extension portion and extended along the first direction to be perpendicular to the second extension portion. The fourth extension portion is coupled to one end of the third extension portion and extended along a direction inverse to the second direction to be perpendicular to the third extension portion. The second radiator is coupled to the first radiator and includes a fifth extension portion and a sixth extension portion. The fifth extension portion is extended from the first extension portion along the second direction to be parallel to the second extension portion. The sixth extension portion is coupled to one end of the fifth extension portion to be parallel to the first extension portion. The feed portion has one end connected to the first extension portion and the other end corresponding to the ground portion.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a dual-band monopole antenna according to an embodiment of the disclosure.

FIGS. 2A-2D show schematic diagrams of monopole antennas configured under different second radiators according to different embodiments of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments of the present disclosure are disclosed below with reference to accompanying drawings. It should be noted that the present disclosure does not illustrate all possible embodiments. The present disclosure can have different variations and is not limited to the embodiments disclosed below. The present disclosure discloses a number of embodiments to meet the legal requirements in application. Designations common to the accompanying drawings are used to indicate identical or similar elements.

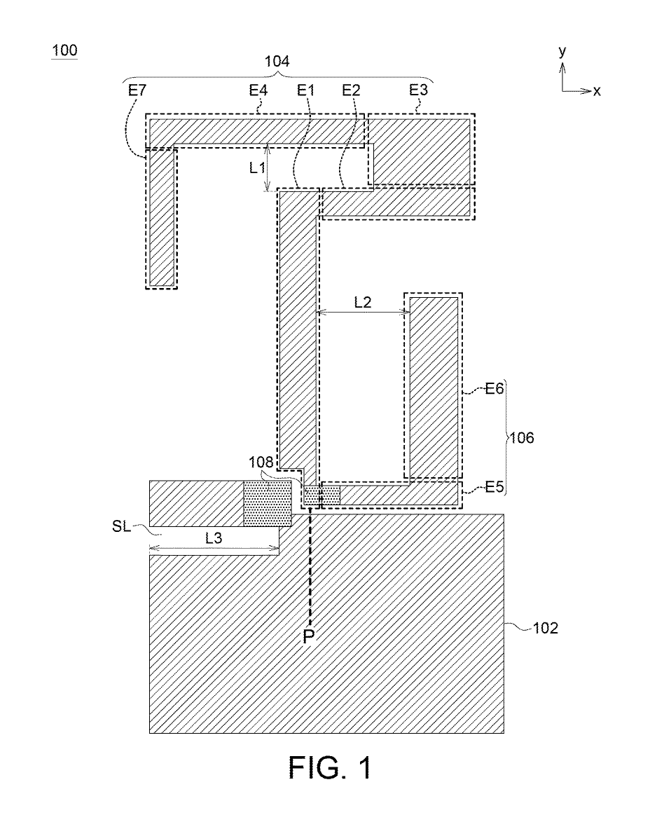

FIG. 1 is a schematic diagram of a dual-band monopole antenna 100 according to an embodiment of the disclosure. The monopole antenna 100 mainly includes a ground portion 102, a first radiator 104, a second radiator 106 and a feed portion 108. The monopole antenna 100 can be printed on a substrate. In an embodiment of the disclosure, the first radiator 104 and the second radiator 106 dominate different antenna operating bands. For example, the first radiator 104 dominates an operating band whose frequency is relatively low, and the second radiator 106 dominates an operating band whose frequency is relatively high.

The first radiator 104 is disposed adjacent to the ground portion 102 but is not directly connected to the ground portion 102. The first radiator 104 mainly includes a first extension portion E1, a second extension portion E2, a third extension portion E3 and a fourth extension portion E4. The first extension portion E1, the second extension portion E2, the third extension portion E3 and the fourth extension portion E4 are sequentially connected end to end to form a continuous metal pattern.

As indicated in FIG. 1, the first extension portion E1 is extended towards the ground portion 102 along a first direction (such as +y direction). The second extension portion E2 is coupled to one end of the first extension portion E1 and is extended along a second direction (such as +x direction) to be perpendicular to the first extension portion E1. The third extension portion E3 is coupled to one end of the second extension portion E2 and is extended along the first direction to be perpendicular to the second extension portion E2. The fourth extension portion E4 is coupled to one end of the third extension portion E3 and is extended along a direction inverse to the second direction (such as −x direction) to be perpendicular to the third extension portion E3. As indicated in FIG. 1, the second extension portion E2, the third extension portion E3 and the fourth extension portion E4 form an U-shaped pattern with the opening facing the −x direction. In an embodiment, the opening of the “U”-shaped pattern has a width L1 for example, ranging between 0.5˜1 mm, such that the antenna can provide better reflection loss under the said operating band.

In an embodiment as indicated in FIG. 1, the first radiator 104 further includes a seventh extension portion E7 coupled to one end of the fourth extension portion E4 and extended along a direction inverse to the first direction (such as −y direction) to be perpendicular to the fourth extension portion E4. In some embodiments, one end of the seventh extension portion E7 can further be bent towards another direction to increase the resonance current path corresponding to the first radiator E1 and reduce the frequency of the operating band.

The second radiator E2 is coupled to the first radiator E1. The second radiator E2 mainly includes a fifth extension portion E5 and a sixth extension portion E6. The fifth extension portion E5 and the sixth extension portion E6 are sequentially connected end to end to form a continuous metal pattern. As indicated in FIG. 1, the fifth extension portion E5 is extended from the first extension portion E1 along the second direction (such as +x direction) to be parallel to the second extension portion E2. The sixth extension portion E6 is coupled to one end of the fifth extension portion E5 to be parallel to the first extension portion E1. In the example illustrated in FIG. 1, the sixth extension portion E6 is extended towards the second extension portion E2 along the first direction (such as +y direction) to form an “L”-shaped pattern with the fifth extension portion E5. In some embodiments, one end of the sixth extension portion E6 can further be bent towards another direction to increase the resonance current path corresponding to the second radiator E2. The sixth extension portion E6 and the first extension portion E1 are separated by a distance L2, for example, larger than 3 mm, such that the antenna can provide better high frequency characteristics.

In an embodiment of the disclosure, the antenna operating band dominated by the first radiator 104 can be adjusted by adjusting the length of at least one extension portion (for example, at least one of E1˜E7) of the first radiator 104, and the antenna operating band dominated by the second radiator 106 can be adjusted by adjusting the length of at least one extension portion (for example, at least one of E5 and E6). In other words, the antenna designer can correspondingly adjust two operating bands of the monopole antenna 100 by adjusting the length of the first radiator 104 and the length of the second radiator 106 to achieve an independent frequency band adjustment mechanism.

One end of the feed portion 108 is connected to the first extension portion E1 and the other end corresponds to the ground portion 102. The feed portion 108 receives a radio frequency signal. For example, the signal end and the ground end of a 50 Ohm cable can be soldered to two ends of the feed portion 108 through which the radio frequency signal is fed to the monopole antenna 100 directly. However, the disclosure is not limited thereto, and the monopole antenna 100 can also receive the radio frequency signal using other generally known signal transmission elements.

In an embodiment as indicated in FIG. 1, the ground portion 102 includes a slot SL extended towards the interior of the ground portion 102 from a lateral side of the ground portion 102 (such as the left-hand boundary of the ground portion 102) along a second direction (such as +x direction). By adjusting the size and length of the slot SL, impedance matching of the monopole antenna 100 can be adjusted accordingly. In an embodiment, the slot SL is extended towards the interior of the ground portion along the second direction but does not exceed the connection point P between the first extension portion E1 and the feed portion 108 so that better impedance matching can be maintained. As indicated in FIG. 1, the length L3 of the slot SL does not exceeds the connection point P between the first extension portion E1 and the feed portion 108.

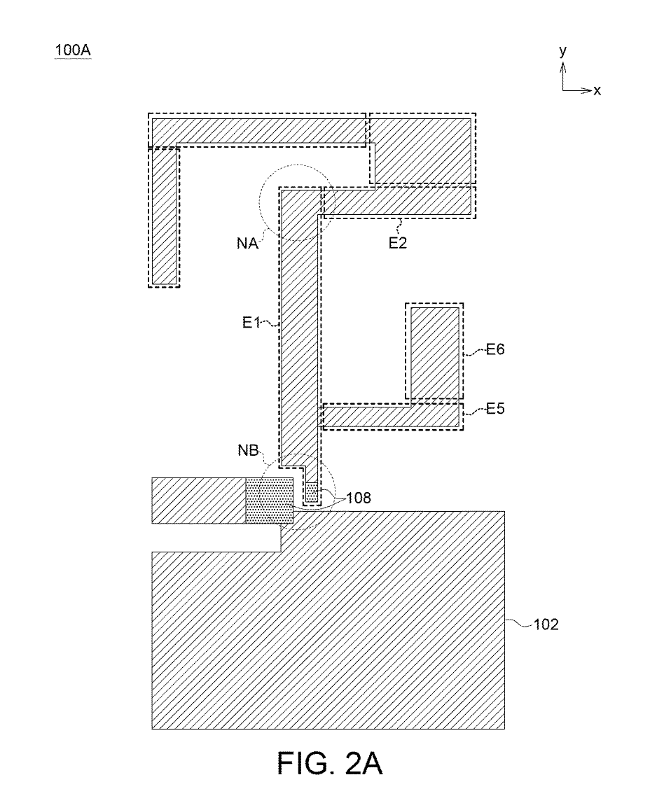

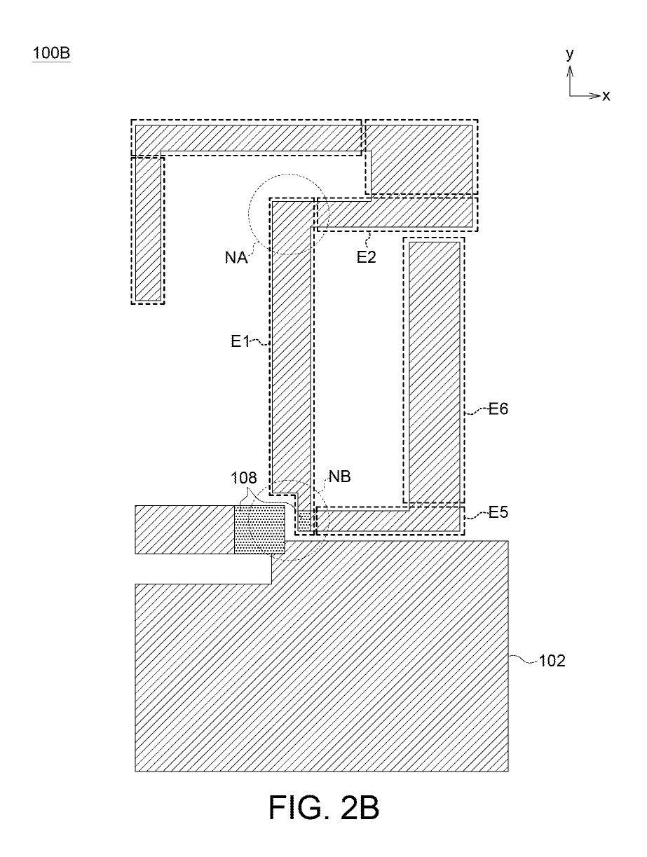

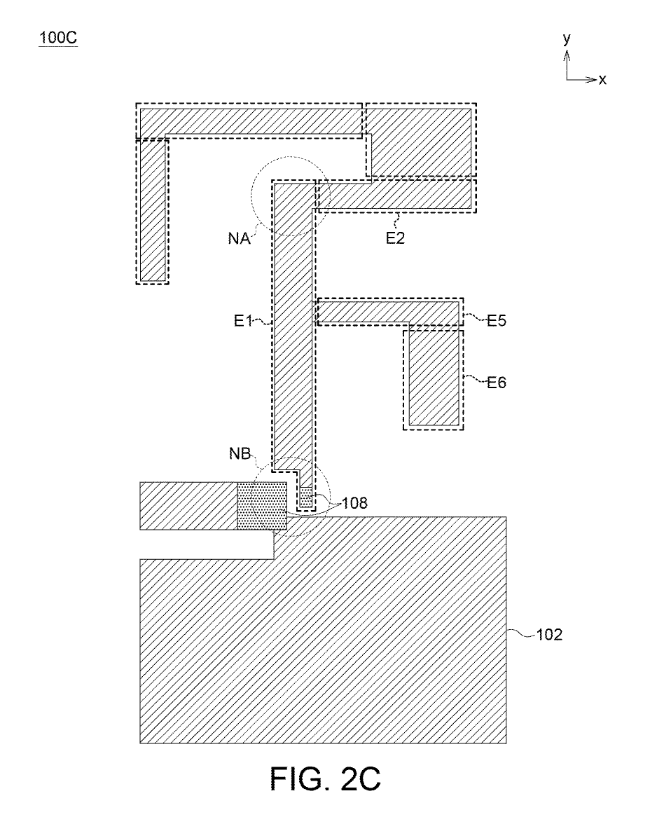

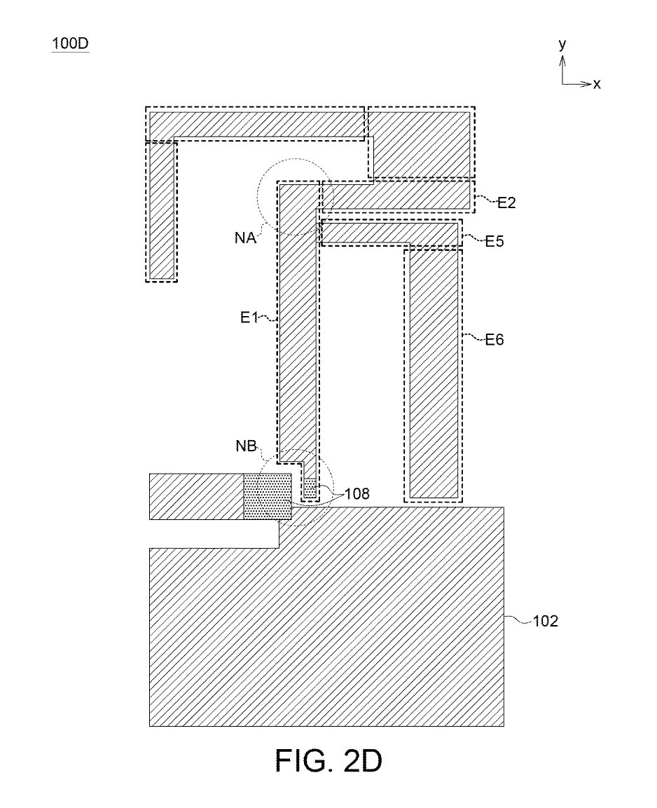

In an embodiment of the disclosure, the second radiator E2 can be regarded as a frequency adjustment unit independent of the first radiator E1. The operating band dominated by the second radiator E2 can be adjusted by moving the position of the second radiator E2 up or down along the lateral side of the first radiator E1. Or, the operating band dominated by the second radiator E2 can be adjusted by adjusting the extending direction and/or length of the sixth extension portion E6 of the second radiator E2. Details of the said adjustment are described below with reference to FIGS. 2A-2D. It should be noted that any monopole antennas generated by making modifications or variations to the embodiments disclosed with reference to the accompanying drawings are still within the spirit of the disclosure.

FIGS. 2A˜2D show schematic diagrams of monopole antennas 100A, 100B, 100C, 100D configured under different second radiators E2 according to different embodiments of the disclosure. The monopole antennas 100A, 100B, 100C, and 100D are similar to the monopole antenna 100 of FIG. 1, and the same designations are used for corresponding components. Furthermore, for the embodiments to be more clearly described, designations of identical components are omitted.

In the example illustrated in FIG. 2A, the fifth extension portion E5 of the monopole antenna 100A is coupled to the middle section excluding the two ends NA and NB of the first extension portion E1. Here, the end NA of the first extension portion E1 refers to, for example, the end by which the first extension portion E1 is connected to the second extension portion E2, and the end NB of the first extension portion E1 refers to, for example, the end by which the first extension portion E1 is connected to the feed portion 108.

Under the circumstance that the pattern of the main body of the second radiator E2 remains unchanged, the farther away from the feed point 108 the second radiator E2 is, the longer the corresponding resonance path (relatively low frequency) will be, Conversely, the closer to the feed point 108 the second radiator E2 is, the shorter the corresponding resonance path (relatively high frequency) will be. The operating band dominated by the second radiator E2 can be adjusted by moving the position of the second radiator E2 up or down. Also, the distance between the fifth extension portion E5 and the ground portion 102 affects the width of the operating band dominated by the second radiator E2, and the smaller the distance, the wider the operating band.

In the example illustrated in FIG. 2B, the fifth extension portion E5 of the monopole antenna 100B is adjacent to the end NB by which the first extension portion E1 is connected to the feed portion 108 and is farther away from the NA end by which the first extension portion E1 is connected to the second extension portion E2. In the present embodiment, the sixth extension portion E6 can be freely extended towards the second extension portion E2 along the first direction (such as +y direction) as long as the sixth extension portion E6 and the second extension portion E2 are not connected together. The operating band dominated by the second radiator E2 can be adjusted by adjusting the length of the sixth extension portion E6. Also, as the distance between the sixth extension portion E6 and the second extension portion E2 becomes shorter, the monopole antenna will produce better reflection loss under the operating band dominated by the second radiator E2.

In the example illustrated in FIG. 2C, the sixth extension portion E6 of the monopole antenna 100C is extended towards the ground portion 102 along a direction inverse to the first direction (such as −y direction). Besides, the fifth extension portion E5 is coupled to the middle section excluding the two ends NA and NB of the first extension portion E1.

In the example illustrated in FIG. 2D, the fifth extension portion E5 of the monopole antenna 100D is farther away from the end NB by which the first extension portion E1 is connected to the feed portion 108 and is adjacent to the end NA by which the first extension portion E1 is connected the second extension portion E2. In the present embodiment, the sixth extension portion E6 can be freely extended towards the ground portion 102 along a direction inverse to the first direction (such as −y direction) as long as the sixth extension portion E6 and the ground portion 102 are not connected together. The operating band dominated by the second radiator E2 can be adjusted by adjusting the length of the sixth extension portion E6.

To summarize, the monopole antenna disclosed in above embodiments of the disclosure is equipped with independent band adjustment mechanism allowing the designer to adjust separate antenna operating band independently. Besides, the monopole antenna can be operated on an independent printed circuit board or used in conjunction with the system, and therefore can be conveniently used in different systems.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A dual-band monopole antenna, comprising:
a ground portion;
a first radiator disposed adjacent to the ground portion, and comprising:
a first extension portion extended towards the ground portion along a first direction;
a second extension portion coupled to one end of the first extension portion and extended along a second direction to be perpendicular to the first extension portion;
a third extension portion coupled to one end of the second extension portion and extended along the first direction to be perpendicular to the second extension portion; and
a fourth extension portion coupled to one end of the third extension portion and extended along a direction inverse to the second direction to be perpendicular to the third extension portion;
a second radiator coupled to the first radiator, and comprising:
a fifth extension portion extended along the second direction from the first extension portion to be parallel to the second extension portion; and
a sixth extension portion coupled to one end of the fifth extension portion to be parallel to the first extension portion; and
a feed portion whose one end is connected to the first extension portion and the other end corresponds to the ground portion.

2. The monopole antenna according to claim 1, wherein the first radiator further comprises:
a seventh extension portion coupled to one end of the fourth extension portion and extended along a direction inverse to the first direction to be perpendicular to the fourth extension portion.

3. The monopole antenna according to claim 1, wherein the sixth extension portion is extended towards the second extension portion along the first direction.

4. The monopole antenna according to claim 1, wherein the sixth extension portion is extended towards the ground portion along a direction inverse to the first direction.

5. The monopole antenna according to claim 1, wherein the fifth extension portion is adjacent to one end by which the first extension portion is connected to the feed portion and is farther away from one end by which the first extension portion is connected to the second extension portion.

6. The monopole antenna according to claim 1, wherein the fifth extension portion is farther away from one end by which the first extension portion is connected the feed portion and adjacent to one end by which the first extension portion is connected to the second extension portion.

7. The monopole antenna according to claim 1, wherein the fifth extension portion is coupled to the middle section excluding the two ends of the first extension portion.

8. The monopole antenna according to claim 1, wherein the ground portion comprises a slot extended towards the interior of the ground portion from a lateral side of the ground portion along the second direction.

9. The monopole antenna according to claim 8, wherein the slot is extended towards the interior of the ground portion along the second direction but does not exceed the connection point between the first extension portion and the feed portion.
